(19) United States
(12) Patent Application Publication
(10) Pub. No.: US 2003/0235477 A1
(43) Pub. Date: Dec. 25, 2003

(54) Multiple drilling platform

(76) Inventor: Steven Mark Schulz, Baton Rouge, LA (US)

Correspondence Address: Steve Schulz, 13336 Avants Ave, Baton Rouge, LA, 70815, US

(21) Appl. No.: 10/178,700

(22) Filed: Jun. 24, 2002

(51) Int. Cl. B23B 47/16

(52) U.S. Cl. 408/48

(57) ABSTRACT

A system designed to drill multiple rows of holes utilizing a simplified belt drive. The basic embodiment of the apparatus comprises of a platform on which several drilling heads are affixed independently on twin axes. The multiple rows of drill bits are arranged in such a way as to allow the top segment of each bit to revolve as well as articulate in a direction at a tangent to the circular drilling motion facilitating the drill into the substrate. The bits are each independent and derive the motion necessary for rotation and reciprocating motion through the interaction of a special belt designed to impart rotary and linear motion. In its most basic embodiment the drill platform is controlled and powered by a single belt drive. The system is able to create twin rows of holes using a simple rotating power source to drive the belt that creates both rotary and linear motion to each of the drill heads.

### REFERENCES CITED

| | | | |
|---|---|---|---|
| 2238578 | Apr., 1941 | Burkemen | 408/22 |
| 2970483 | Feb,. 1961 | Schruin Sr. | 74/22 R |
| 3260289 | Jul., 1966 | Whitten, Jr | 83/699.21 |
| 3327749 | Jun., 1967 | Hunn | 408/22 |
| 3704517 | Dec., 1972 | Deterling | 408/26 |
| 5676497 | Oct., 1997 | Kim | 408/21 |
| 5560408 | Oct., 1996 | DiFranco | 144/144.1 |
| 6094826 | Sep., 1998 | Schmidt | 30/369 |
| 6099212 | Aug., 2000 | Marocco | 408/3 |

### BACKGROUND OF INVENTION

1. Field of the Invention

The present invention relates to a multiple head boring machine. Multiple head drilling equipment is desirable to expedite line-boring operations. Most boring equipment is large and expensive to own and bulky in its common form. The nature of this equipment is complicated because of the need to drive multiple drilling heads using gears and pulleys. In addition the drills have to be aligned with a work piece and articulated to engage the substrate while rotating the drill heads. These large machines are cumbersome in small places and the work piece has to be maneuvered within the drill heads range. A need to bring the drills to the workpiece has been identified. This advantage allows a portable drill head to access the workpiece while the piece is in place in the assembly and insures that alignment is more manageable.

2. Description of Prior Art

In general line-boring equipment has been in use for many years. Typically this equipment has a large frame weighing hundreds of pounds. The drill platform has various jigs and guides to achieve proper alignment when the workpiece is brought to the drill platform in readiness for drilling Many segments that need to be drilled are left and right components. This inherently provides room for error due to the ability of an operator to reverse a panel and drill a pattern that does not compliment the opposite side.

The reason that most line boring machines are large and heavy is the need to drive the drilling heads while articulating the drills to bore the holes. This has to be accomplished as the workpiece is held stationary and in the correct alignment The problem with panel alignment prior to the drilling operation is significant Many innovations and complex jigs are in use to accomplish these goals.

The larger the panel that needs to be drilled, the more difficult it is to align left and right components. The number of drills involved in any specific line borer play a function when drilling large panels. The converse is that small panels cannot easily be accommodated without removing some of the drills.

Therefore, while Line boring equip is known in the prior art, all of the known prior art embodiments contain the disadvantages set forth above. Stationary drilling stations, complex positioning jigs, error prone alignment.

### SUMMARY OF THE PRESENT INVENTION

The present invention relates to a novel design for driving a portable boring machine. The novel design allows a single low power motor source to drive multiple drill heads utilizing a single belt. What is provided is an apparatus that is a self-contained drill platform. The multiple drilling platform is designed as a portable unit. Using a single source power supply enables the apparatus to function with significantly reduced weight. This reduction in weight is possible due to a novel driving mechanism. This type of drive mechanism enables the drills to be fastened independently while they are rotated and reciprocated utilizing a single belt to drive both

In operation the multiple drill is positioned on the workpiece. The workpiece can be partially assembled to make sure the drill is aligned correctly. Once the drill is in position there is a means to lock the drill head stationary before starting the boring operation. A single motor can be used to drive the drill heads and once it is engaged the mechanism revolves and moves a stiff belt that engages each drill head. The belt is aligned in such a way as to rotate each drill head then by utilizing a belt that varies in thickness the same belt produces a reciprocating motion that can advance the drill head into the workpiece.

In order to drill multiple holes with a small torque motor it is advantages to establish a technique that allows one drill head at a time to engage the work surface. This is easily achieved by changing the width of the driving belt by small increments so that each drill head is advanced and engages the workpiece by a small amount then the next head is incremented and so on for the total number of drill heads in the machine. Once each individual drill head engages the substrate the workload to that head is removed, this frees up the motors torque to be available for the next drill head to increment into the substrate.

This incremental motion allows the torque to distribute to each drill head when it needs it, while freeing up the motor load before the next drill head needs it. This procedure creates a multiple drill platform that drills a series of holes in sequence using a small torque motor. This in part allows the multi drill head to be lightweight and maintain a small size.

### BRIEF DESCRIPTION OF THE DRAWING

For a further understanding of the nature and objects of the present invention, reference should be had to the following description taken in conjunction with the accompanying drawing in which like parts are given like reference numerals and wherein:

FIG. 1 is a perspective view of the working components of the preferred embodiment of the apparatus of the present invention in a typical configuration;

FIG. 2 is a cross section blow up of a drill head of the preferred embodiment of FIG. 1 in a retracted position;

FIG. 3 is a cross section blow up of a drill head of the preferred embodiment similar to FIG. 2, in a extended position;

FIG. 4 is a side view of the belt section articulating along the path while engaging drill heads in the process of the preferred embodiment of the apparatus;

FIG. 5 is a top of view of the preferred embodiment with parts omitted for clarity demonstrating a typical compact configuration;

FIG. 6 is a top of view of the preferred embodiment with parts omitted for clarity similar to FIG. 5, demonstrating a typical expanded configuration;

FIG. 7 is a an expanded top view of the preferred embodiment with parts omitted for clarity similar to FIGS. 5 & 6, demonstrating a typical belt path;

FIG. 8 is a side view of the preferred embodiment with parts omitted for clarity demonstrating drill heads in a retracted configuration;

FIG. 9 is a side view of the preferred embodiment with parts omitted for clarity demonstrating drill heads in an extended configuration.

### DETAILED DESCRIPTION OF THE PREFERRED EMBODIMENT

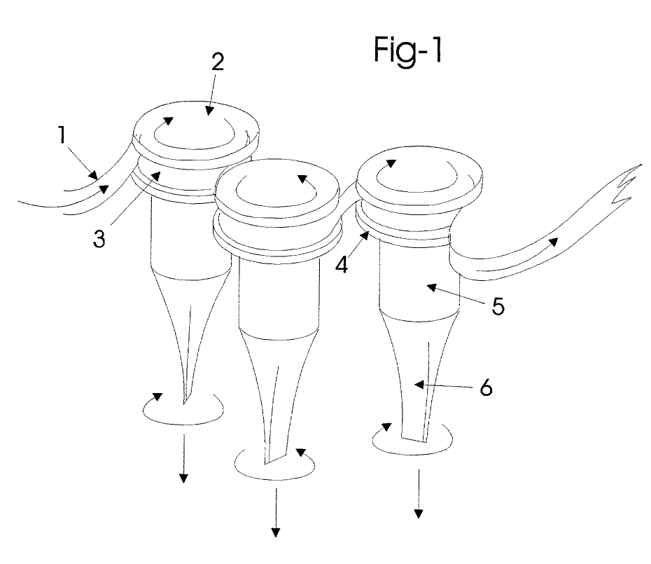

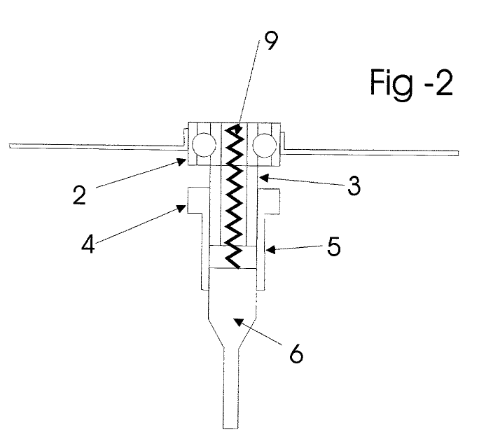

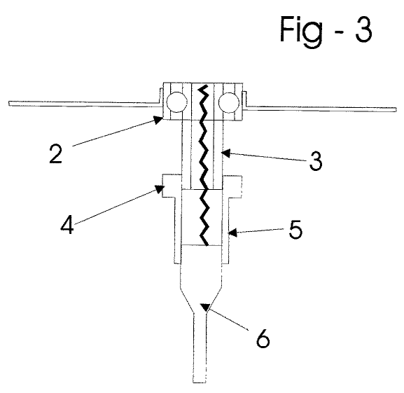

Referring now to the drawing and in particular FIG. 1. The primary apparatus of the present invention are comprised of drill heads like those depicted in FIG. 1. Each drill head of the preferred embodiment has several elements in common. Belt 1 is the primary generation of motion to provide rotational action by winding around reel 3 and equally producing reciprocating motion controlled by belt 1 as it rides between the top of pulley 2 and the bottom of the pulley 4. The drill head assembly is affixed in this embodiment to the frame by means of bearing 2 which also serves as the guide for belt 1, see FIG. 2 and FIG. 3.

The Belt engages the body of the drill section by wrapping around segment 3 of the drill head and providing rotary motion as belt 1 is in motion. As the belt travels it varies in thickness, this variance displaces the top plate 2 and the bottom plate 4. The drill head now rotates due to the friction of belt 1 on the body 3 of the drill head, and this section is coupled to the drill 6. FIG. 2 and 3 depict a sequence of belt travel past a drill head shown on a side view. The drill segment 4 is the base cap and is affixed to the drill 6 and coupled to the rotor 3 which forms the rotation portion of the drill head. As the belt advances it increases in thickness along its linear axis.

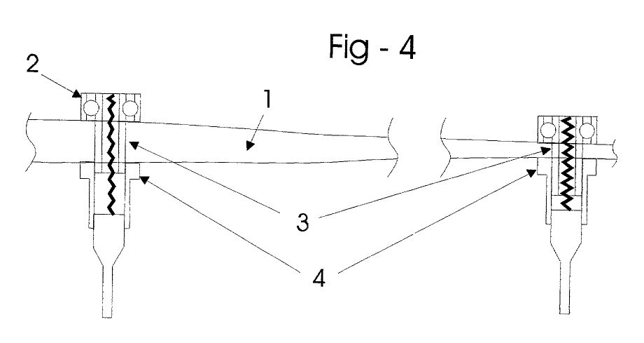

This change in width displaces the top pulley 2 and the bottom pulley 4 allowing the drill 6 to articulate at a right angle to the direction of rotation. As the belt advances the thickness variation translates into a linear motion as depicted in FIG. 2 in a retracted state while FIG. 3 represents an extended drill. FIG. 4 represents a time sequence showing the variation of belt 1 width in relation to the drill body 3 and top cap 2 and bottom cap 4. Each drill head can be free rotating and dependant on motion via the belt drive.

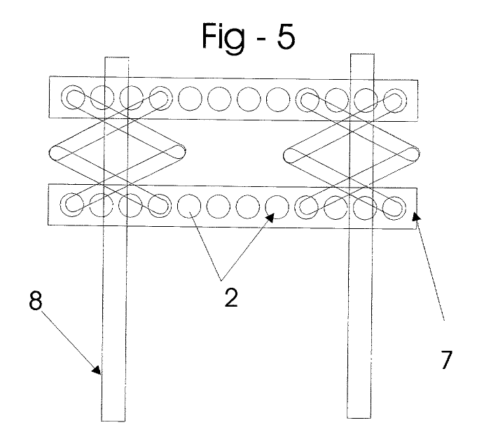

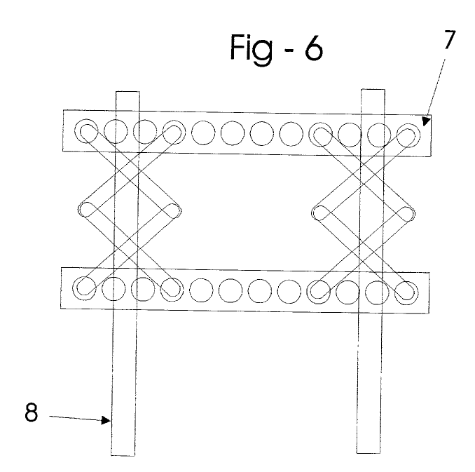

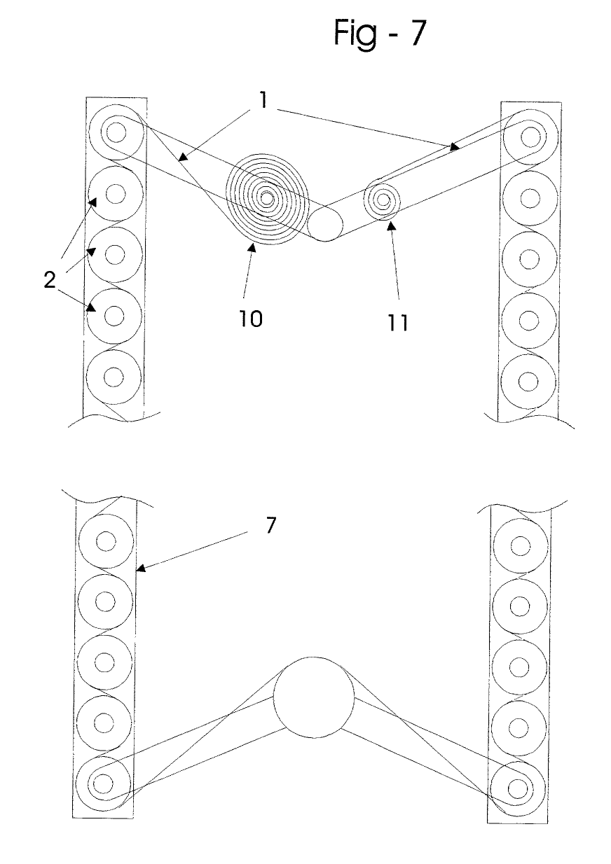

In FIG. 5 and 6 you can see a top view and the relationship of the drill heads affixed to a frame 7. The view shows a representation of multiple drills in a typical configuration. The ability to shift the rows of drills along the guide 8 is important due to variations in workpieces. Using a belt drive allows the drill system to shift the width relationship along the axis defined by guide 8 without effecting the performance of the drill platform. FIG. 7 is a top view showing a more detailed view of a typical path defined by the belt 1. The reel 10 is affixed via gearbox to a motor which drives the drill heads by rotating reel 10 and 11 to advance the belt and articulate the drill heads.

By controlling the width of drive belt 1 the drill mechanism creates the means to reciprocate the drill heads as well as provide rotation. To keep the power requirements to a minimum it is possible to space out the graduations in width of the drive belt so that only one drill head at a time would be advanced into the workpiece. The advantage of this technique is to use the available torque on one drill at a time. Once each drill has advanced into the workpiece the load is effectively removed and the torque is available for the next head in sequence. By displacing each head by a small amount the torque requirements can be reduced to a point that can be fulfilled by using a small drill or motor.

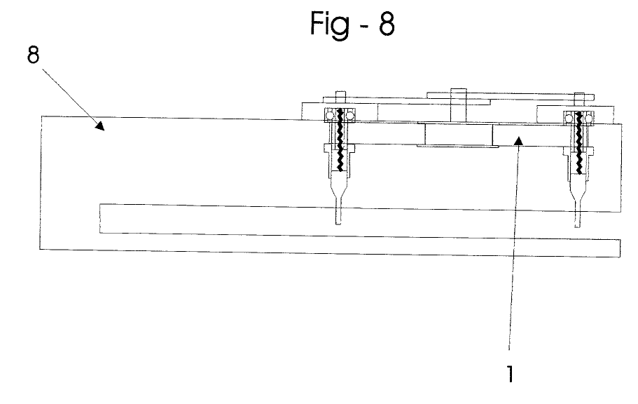

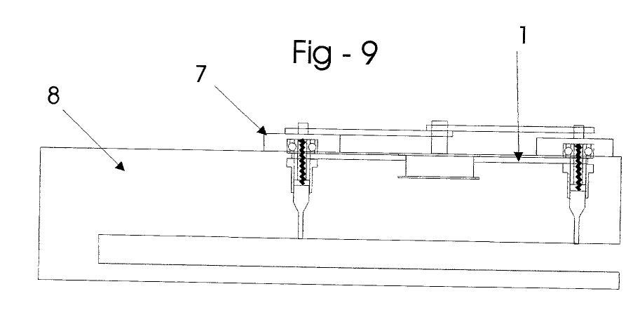

Looking at the device from an end view as in FIGS. 8 and 9 permits a view of the work and the clamping mechanism 8 needed to fasten the workpiece while the drills are articulated to engage the substrate.

As can be seen from the drawing and above description, the apparatus of the present invention is simple in design, requiring only a few parts. Furthermore, the apparatus is made simply with ordinary inexpensive items, thus being easy and economical to manufacture.

Because many varying and differing embodiments may be made within the scope of the inventive concept herein taught and because many modifications may be made in the embodiment herein detailed in accordance with the descriptive requirement of the law, it is to be understood that the details herein are to be interpreted as illustrative and not in a limiting sense.

What is claimed as invention is:

1. An apparatus for drilling multiple holes, comprising:
(a) Self contained drill heads affixed to a frame.

2. The apparatus of claim 1, wherein said drill head is designed to rotate via a belt drive.

3. The apparatus of claim 2, wherein said drill head is designed to displace along a vertical axis while remaining coupled to the rotational axis.

4. The apparatus of claim 3, wherein said drill head is rotated and reciprocated via a belt drive that has a variable width that creates the rotary motion as well as the reciprocating motion of the drill head

5. The apparatus of claim 4, wherein said belt is constructed of a substantially stiff material, enabling the drill heads to be rotated by said belt while at the same time articulated at a right angle by a change in the belt width.

6. The apparatus of claim 5, wherein said belt width determines the length of the drill depth and the pattern of the varying incremental width of said belt creates the timing in the drilling pattern. This allows one drill to incrementally engage the workpiece at a time, so that the workload is not shared among all the drill heads but distributed to a one or two heads at any given second.
